(19) United States
(12) Patent Application Publication
(10) Pub. No.: US 2003/0174232 A1
(43) Pub. Date: Sep. 18, 2003

(54) Focus detecting system

(76) Inventors: Satoshi Yahagi, Tokyo (JP); Atsushi Kanayama, Kawashima Town (JP)

Correspondence Address: Arnold International, P. O. BOX 129, Great Falls, VA, 22066, US

(21) Appl. No.: 10/360,643

(22) Filed: Feb. 10, 2003

(30) Foreign Application Priority Data
Mar. 13, 2002 (JP) 2002-068773

(51) Int. Cl. H04N 5/232

(52) U.S. Cl. 348/345; 348/355

(57) ABSTRACT

A focus detecting system for determining the focus state of an adjustable focus imaging lens includes a first beamsplitter for separating light for image production and light for detection of the focus state of the adjustable focus imaging lens in the ratio of 2:1. Only two focus state detecting elements are used, each of which receives from a second beamsplitter one-sixth of the amount of light that enters the adjustable focus imaging lens. Light receiving surfaces of the two focus state detecting elements are equidistant from image planes that are conjugate to an image plane for image production. The focus state detecting elements operate in the contrast mode using high frequency components of video signals to produce evaluation values that indicate an in-focus state of the imaging system by being equal. In one embodiment, the images that the focus state detecting elements detect are not reverted.

### BACKGROUND OF THE INVENTION

Autofocus (hereinafter AF) of imaging devices, such as video cameras and similar cameras, using image detecting elements is generally based on the contrast mode. The contrast mode integrates high frequency components of projected image signals in some range (focus area) among projected image signals (brightness signals) obtained from an image detecting element as an evaluation value and automatically makes a focus adjustment so as to maximize the evaluation value. The contrast mode gives the best focus with a maximum sharpness (contrast) of an image at an image detecting element for image production. However, the contrast mode searches for the best focus while moving focusing lens elements in what is called a hill-climbing mode, which has the disadvantage of a slow rate of focusing.

Accordingly, AF systems and methods wherein the focus state (front focus, back focus, and in-focus) of an imaging lens is detected to control the focus by using multiple image detecting elements with different optical path lengths have been proposed to resolve the drawback of such a contrast mode. In order to control focus, these AF systems detect the focus state at an image detecting plane where a light receiving surface of an image detecting element for image production is located by positioning, near planes that are conjugate to that image detecting plane, light receiving surfaces of the focus state detecting elements. The light receiving surfaces of the focus state detecting elements are placed equidistant in front of and behind those conjugate planes. The two focus state detecting elements obtain quantitative evaluation values indicative of the focus state at each of the pair of focus state detecting elements.

In such AF systems and methods, the object light is divided between object light for image production and object light for focus detection and then the object light for focus detection is divided three ways among focus state detecting elements. Therefore, the amount of light directed to each focus state detecting element becomes low. Additionally, complex structures are required to properly divide the light three ways among the three focus state detecting elements.

### BRIEF SUMMARY OF THE INVENTION

The present invention relates to an AF system that controls the focus of an adjustable focus imaging lens by a contrast mode that allows the amount of light that passes to the image detecting element for image production relative to the amount of light that passes to each focus state image detecting element of the AF system to be increased.

### BRIEF DESCRIPTION OF THE DRAWINGS

The present invention will become more fully understood from the detailed description given below and the accompanying drawings which are given by way of illustration only and thus are not limitative of the present invention, wherein:

FIG. 1 shows a cross-sectional view of a camera using an AF system according to Embodiment 1 of the present invention;

FIG. 2 shows, for purposes of explanation of operation only, the image detecting planes for two focus state detecting elements of the present invention drawn as being positioned on opposite sides of an image detecting plane for image production along the same straight line, however, in actuality these image detecting planes are positioned, for example, as shown in FIG. 1;

FIG. 3 is a schematic block diagram of the electrically connected elements of an AF system of the present invention;

FIG. 4 is a graph with focus position as the X-axis and evaluation values as the Y-axis of an AF system of Embodiment 1 of the present invention;

FIG. 5 is a flow chart of a process of initiating focus control of an AF system of the present invention;

FIG. 6 is a flow chart of a process of executing focus control of an AF system according to Embodiment 1 of the present invention;

FIG. 7 shows a cross-sectional view of a camera using an AF system of Embodiment 2 of the present invention;

FIG. 8 shows a cross-sectional view of a camera using an AF system of Embodiment 3 of the present invention; and

FIG. 9 shows a cross-sectional view of a camera using an AF system of Embodiment 4 of the present invention.

### DETAILED DESCRIPTION

Four preferred embodiments of the autofocus system of the present invention will now be individually described with reference to the drawings.

### Embodiment 1

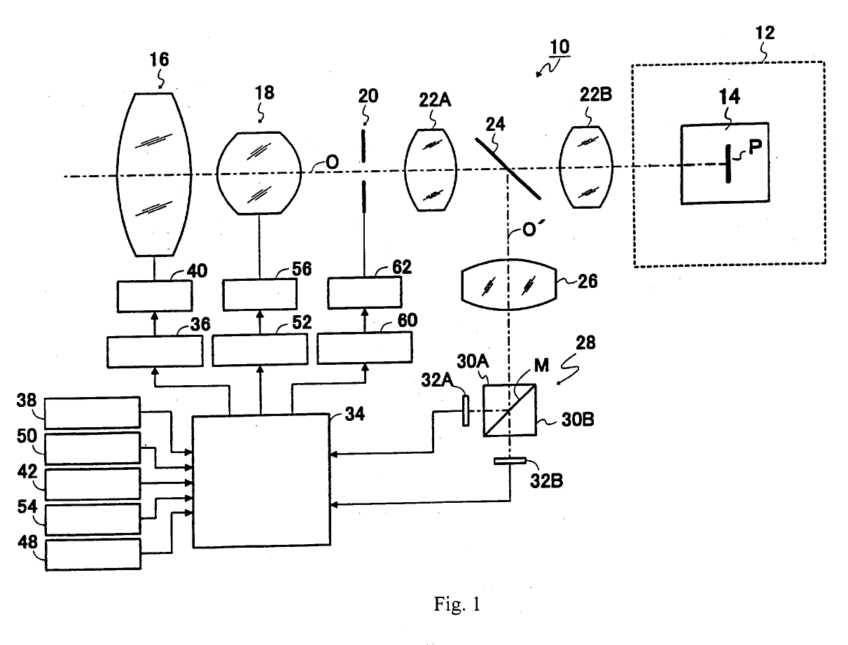

FIG. 1 shows a cross-sectional view of a camera using an AF system of Embodiment 1 of the present invention. As shown in FIG. 1, the camera system, or imaging system, includes a camera body 12 and an adjustable focus camera lens (i.e., an adjustable focus imaging lens 10). The camera body 12 includes an image pickup unit 14 with at least one image detecting element for image production and provides for outputting or storing in memory media image signals of a specified format with appropriate circuits. The adjustable focus imaging lens 10 is detachably mounted on the camera body 12 by mating mounts (not shown) on the adjustable focus imaging lens 10 and the camera body 12.

As shown in FIG. 1, the adjustable focus imaging lens 10 includes a focusing lens 16, a zoom lens 18, an iris 20, and a relay lens, as is known in the art. The relay lens includes, in order from the object side of the adjustable focus imaging lens 10, a front relay lens 22A, a partially reflecting mirror 24, and a rear relay lens 22B. The term “lens” as used herein is generic to one or more lens groups, lens components, and lens elements, except that relay lens clearly includes at least one lens element in each of the front relay lens 22A and the rear relay lens 22B. All the lenses operate in a conventional manner. Therefore, the details of such lenses are not disclosed herein because such details are not necessary to implement the present invention.

The partially reflecting mirror 24 separates object light for focus state detection from light directed toward the image pickup unit 14. The partially reflecting mirror 24 is inclined at approximately a forty-five degree angle to the optical axis O of the adjustable focus imaging lens 10 and reflects one-third of the object light that is incident onto it along a second optical axis O′. The partially reflecting mirror 24 is located so as to reflect the object light that is transmitted through the front relay lens 22A at a right angle to separate that object light from the image forming object light that passes to the image pickup unit 14. That is, the object light transmitted through the partially reflecting mirror 24 exits from the rear of the adjustable focus imaging lens 10 as object light for image production and enters the image pickup unit 14 of the camera body 12.

The configuration of the image pickup unit 14 will not be discussed in detail, since its configuration is not part of Embodiment 1 of the present invention. However, it is noted that light entering the image pickup unit 14 is separated into red, green, and blue light beams by, for example, a color separating optical system, and each different color light beam is incident on a light receiving surface that is at a focused image plane P, which is the image detecting plane for image production, on the first optical axis O of the adjustable focus imaging lens 10 or at an equivalent focused image plane (not shown) of a different image detecting element for image production. This provides the detection of light from which color images may be broadcast or recorded.

The object light that is reflected by the partially reflecting mirror 24 proceeds along the second optical axis O′ orthogonal to the first optical axis O and enters a focus state detection unit 28 after passing through a relay lens 26. As shown in FIG. 1, the focus state detection unit 28 includes a beamsplitter formed of two prisms 30A and 30B and two focus state detecting elements 32A and 32B that define focus state detecting planes at light receiving surfaces where the incident object light strikes the focus state detecting elements 32A and 32B.

As explained above, the partially reflecting mirror 24 divides the object light that has entered the adjustable focus imaging lens 10 into two light beams, one for focus state detection and one for image production. The partially reflecting mirror 24 divides the object light so that the amount of object light directed through the partially reflecting mirror 24 toward the relay lens 22B is twice the amount of light that is directed toward the first and second focus state detecting elements 32A and 32B along the second optical axis O′. That is, preferably, the amount of light to be used for image production is in the ratio of 2:1 to the object light to be used for focus detection. In other words, two-thirds of the amount of light that enters the adjustable focus imaging lens 10 is directed as object light for image production and one-third of the amount of light that enters the adjustable focus imaging lens 10 is directed as focus state detection light.

As shown in FIG. 1, the object light reflected by the partially reflecting mirror 24 travels along the second optical axis O′ through the relay lens 26 and enters the first prism 30A. Then partially reflecting surface M equally divides the incident object light into transmitted light that enters the second prism 30B and into reflected light. The reflected light is directed to focus state detecting element 32A and the equal amount of transmitted light is directed to focus state detecting element 32B. Therefore, one-sixth of the total amount of object light that enters the adjustable focus imaging lens 10 is directed to each of the focus state detecting elements 32A and 32B.

Although light on the second optical axis O′ is divided at the partially reflecting surface M, the second optical axis O′ is generally described as extending to both focus state detecting elements 32A and 32B based on their locations being close to the partially reflecting surface M. Therefore, for example, optical path lengths to both focus state detecting elements 32A and 32B are measured along the second optical axis O′ even though the second optical axis O′ is divided at the partially reflecting surface M just before reaching the focus state detecting elements 32A and 32B, and the focus state detecting elements 32A and 32B are both considered to be located along the second optical axis O′.

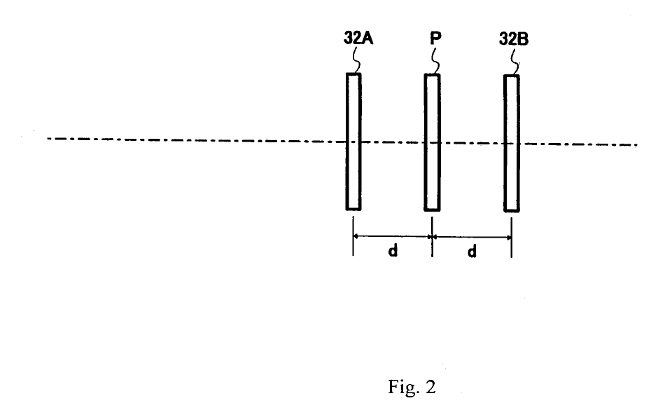

FIG. 2 shows, for purposes of explanation of operation only, the positions of the image detecting planes for the two focus state detecting elements 32A and 32B of the present invention being drawn as positioned on opposite sides of an image detecting plane for image production and along the same straight line. However, in actuality these image detecting planes are positioned as shown in FIG. 1. As shown in FIG. 2, the optical path length of the object light received at the light receiving surface of the first focus state detecting element 32A is substantially shorter than that of the object light received at the light receiving surface of the second focus state detecting element 32B. Additionally, the first focus state detecting element 32A and the second focus state detecting element 32B are equidistant in front of, and in back of, positions that are conjugate to the position of the image detecting plane for image production P, respectively. It is not necessary that the first and second focus state detecting elements 32A and 32B detect different color images, and therefore, charge coupled devices (CCDs) that are used in producing black and white images may be used as the first and second focus state detecting elements 32A and 32B.

As shown in FIG. 1, images received by the pair of focus state detecting elements 32A and 32B are output to a signal processor 34, and, as will be described later, the signal processor 34 detects the focus state of the adjustable focus imaging lens 10 based on the image signals acquired from the pair of focus state detecting elements 32A and 32B. If the focusing mode is the AF mode (auto-focusing mode), as will be described later, a control signal is output to a focus motor driving circuit 36 based on the detected focus state, and focusing of the adjustable focus imaging lens 10 is controlled by autofocusing.

On the other hand, in the MF (manual focusing) mode, the signal processor 34 provides control signals to the focus motor driving circuit 36 based on operation of a focus command circuit 38 so as to control the adjustable focus imaging lens 10 for focusing. The focus command circuit 38 provides focus command data to the signal processor 34 that indicates the position of the focusing lens 16 according to the amount of rotation of a focusing knob (not shown) provided in a free rotational manner.

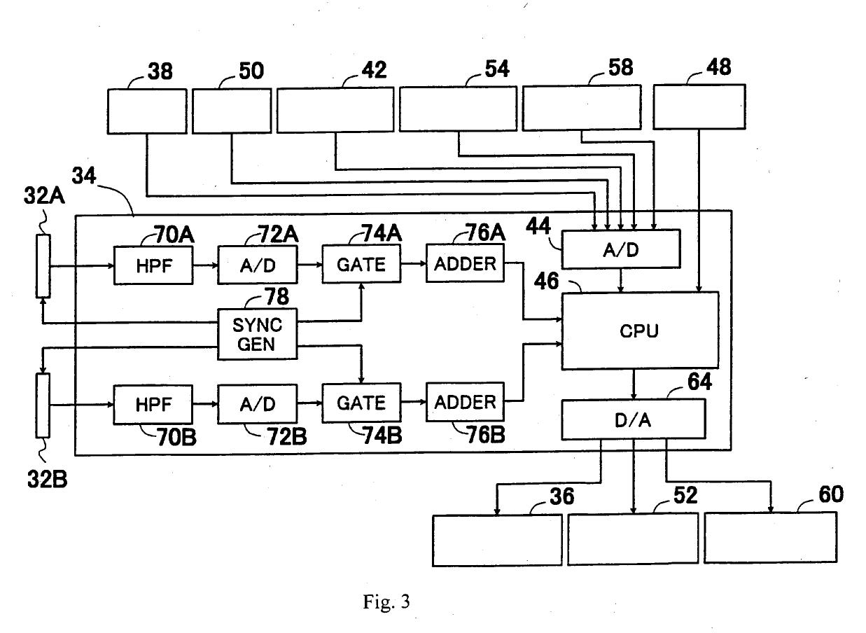

As shown in FIG. 3, the signal processor 34 receives focus command data from the focus command circuit 38 and position data of the focusing lens 16 from a focusing lens position detector 42 via an A/D converter 44 that outputs to a CPU 46. Based on that data, the CPU 46 computes a moving velocity for the focusing lens 16 and outputs a control signal for a focusing motor 40 (FIG. 1) via a D/A converter 64 to the focus motor driving circuit 36. Note that switching the focusing modes between AF and MF modes is performed by the ON/OFF operation of an AF switch that is, as shown in FIG. 3, directly connected to CPU 46. When the AF switch is ON, the AF mode is set and the CPU 46 executes autofocusing control.

The signal processor 34 also outputs a control signal to a zoom motor driving circuit 52 to control the adjustable focus imaging lens 10 for zooming based on operation information of a zoom command circuit 50 that controls the adjustable focus imaging lens 10 for zooming. The zoom command circuit 50 outputs to the signal processor 34 zoom command data that indicates the shift amount of the zoom lens according to the direction and amount of rotation of a zoom ring provided in a free rotational manner. The signal processor 34 provides the zoom command data to the CPU 46 via the A/D converter 44. The CPU 46 calculates the displacement of the zoom lens 18 (FIG. 1) based on the acquired zoom command data and the position data of the zoom lens 18 that is provided from a zoom position detector 54 via the A/D converter 44, and outputs a control signal for a zoom motor 56 to the zoom motor driving circuit 52 via the D/A converter 64.

In addition, the CPU 46 of the signal processor 34 calculates the driving amount of an iris motor 62 based on diaphragm opening or setting data provided from a diaphragm diameter detector 58 via the A/D converter 44 to the CPU 46, and an iris control signal provided from the camera body 12, and outputs an iris control signal for the iris motor 62 to an iris motor control circuit 60 via the D/A converter 64.

Next, the process of detecting the focusing state in the signal processing unit 34 will be explained. As indicated in FIG. 3, images of an object taken individually by the focus state detecting elements 32A and 32B are output as video signals of specified formats, and converted by high-pass filters 70A and 70B, A/D converters 72A and 72B, gate circuits 74A and 74B, and adders 76A and 76B to signals that are evaluation values, which indicate the sharpness of the detected images in terms of image contrast, that are input to the CPU 46.

The process of determining evaluation values will now be described in more detail. Because the focus state detecting elements 32A and 32B are both CCDs that detect images in terms of black and white, the video signals output from each of the focus state detecting elements 32A and 32B are brightness signals related to the brightness of pixels at the light receiving surfaces of the focus state detecting elements 32A and 32B. The video signals from the focus state detecting elements 32A and 32B are input to the high-pass filters 70A and 70B, respectively, and their high-frequency components are extracted.

The high-frequency component signals extracted by the high-pass filters 70A and 70B are converted into digital signals by the A/D converters 72A and 72B. Then, only the digital signals which correspond to pixels within a specified focus area (for example, the central part of the images detected at the light receiving surfaces of the focus state detecting elements 32A and 32B) of the digital signals for the images received over the entire light receiving surfaces (for one field) of the focus state detecting elements 32A and 32B are extracted by the gate circuits 74A and 74B. Then, values of the digital signals in the extracted range are added by the adders 76A and 76B. In this manner, the total sum of the values of the high-frequency components of the video signals within each focus area is obtained. The values acquired by the adders 76A and 76B are evaluation values that indicate the sharpness of the images in terms of the degree of contrast within each focus area.

Moreover, various synchronization signals are supplied to the circuits, such as the focus state detecting elements 32A and 32B and the gate circuits 74A and 74B, from a synchronization signal generation circuit 78 (FIG. 3), in order to synchronize the processing of the circuits. Also, a vertical synchronization signal (V signal) for every field of video signal is supplied from the synchronization signal generation circuit to the CPU 46.

The CPU 46 detects the current focus state of the adjustable focus imaging lens 10 at the image detecting plane (focused image plane P) of the image detecting element for image production based on the evaluation values obtained from the focus state detecting elements 32A and 32B as described above.

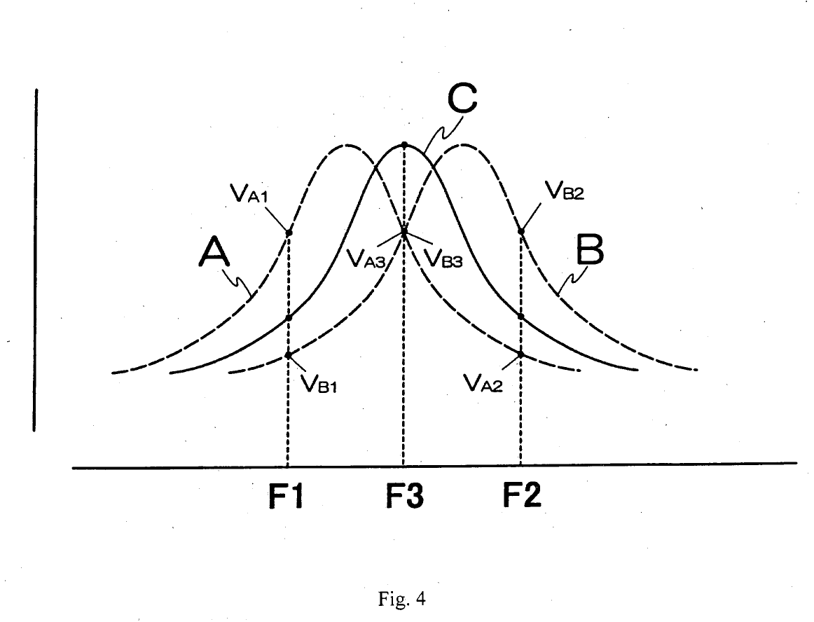

The process of detecting the focus state of the adjustable focus imaging lens 10 by the CPU 46 will now be described with reference to FIG. 4. FIG. 4 is a graph with focus position as the X-axis and evaluation values as the Y-axis for the adjustable focus imaging lens 10 that shows evaluation values in relation to focus positions when an object is imaged. In FIG. 4, a curve C indicates evaluation values acquired from the image detecting element for image production plotted against focus positions, and curves A and B in FIG. 4 indicate evaluation values acquired from the focus state detecting elements 32A and 32B plotted against the focus positions, respectively. In FIG. 4, the position F3 where the evaluation value on the curve C becomes the maximum is the focused image position.

When the focus position of the adjustable focus imaging lens 10 is set to F1, the evaluation value V_{A1} acquired from the focus state detecting element 32A is the value corresponding to the position F1 on the curve A, and the evaluation value V_{B1} acquired from the other focus state detecting element 32B is the value corresponding to the position F1 on the curve B. It is clear that these evaluation values indicate a focus state where the evaluation value V_{A1} acquired from focus state detecting element 32A is greater than the evaluation value V_{B1} acquired from focus state detecting element 32B. Thus the focus position is set on the near side of the in-focus position for the image detecting element for image production F3, that is, in the front focus state.

On the other hand, when the focus position of the adjustable focus imaging lens 10 is set to F2, the evaluation value V_{A2} acquired from focus state detecting element 32A is the value corresponding to the position F2 on the curve A, and the evaluation value V_{B2} acquired from the other focus state detecting element 32B is the value corresponding to the position F2 on the curve B. It is clear that these evaluation values indicates a state where evaluation value V_{A2} acquired from focus state detecting element 32A is smaller than the evaluation value V_{B2} acquired from the other focus state detecting element 32B, and thus the focus position is set on the far, or infinity, side of the in-focus position F3, that is, in the back focus, or rear focus, state.

In yet another case, when the focus position of the adjustable focus imaging lens 10 is set to the in-focus position F3, that is, the in-focus position for the image detecting element for image production, the evaluation value V_{A3} acquired from focus state detecting element 32A is the value corresponding to the position F3 on the curve A, and the evaluation value V_{B3} acquired from the other focus state detecting element 32B is the value corresponding to the position F3 on the curve B. The equality of the evaluation value V_{A3} acquired from the focus state detecting element 32A with the evaluation value V_{B3} acquired from the focus state detecting element 32B indicates that the adjustable focus imaging lens 10 is in the in-focus position F3.

In this way, whether the focus state of the adjustable focus imaging lens at the present focus position is that of front focus, back focus, or in-focus can be determined based on the evaluation values, denoted generally as V_{A} and V_{B}, acquired from the focus state detecting elements 32A and 32B.

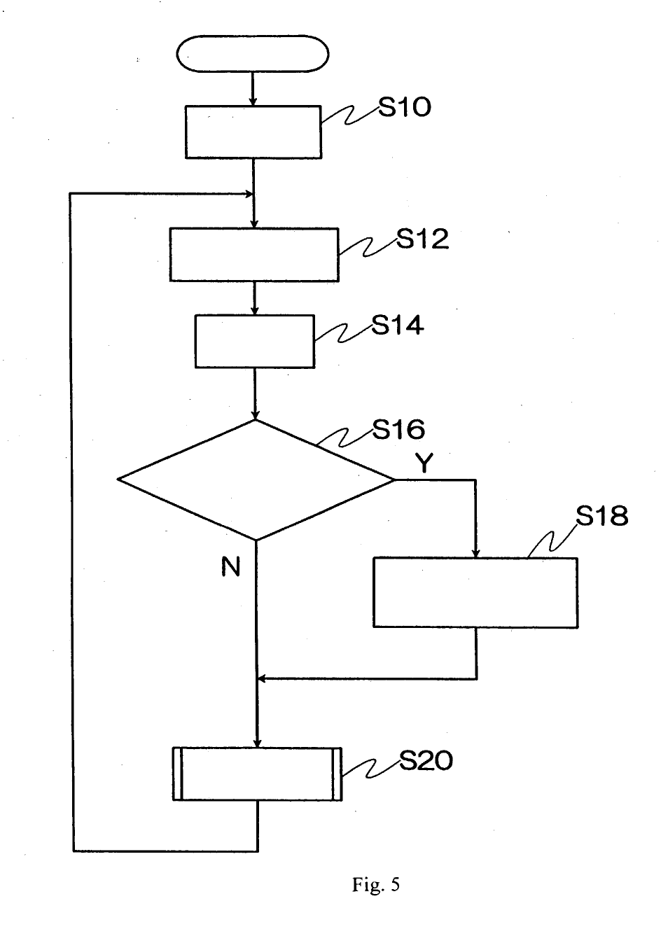

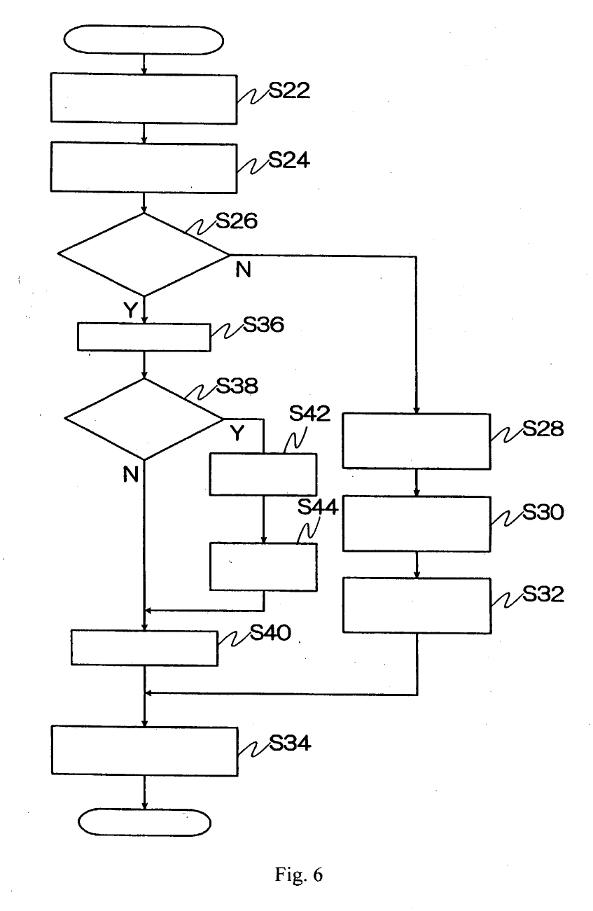

Next, the processing procedure of focusing control in an imaging system, such as a TV camera system, configured as described above is explained according to the flow charts shown in FIG. 5 and FIG. 6.

As shown in FIG. 5, first, after performing necessary initial settings (step S10), the CPU 46 performs an iris control based on an iris control signal supplied from the camera body 12 (step S12). Next, based on the operating information of zoom command circuit 50, the CPU 46 performs zooming control of the adjustable focus imaging lens 10 (step S14). Next, the CPU 46 determines whether the AF switch is ON or not (step S16), and if the AF switch is ON, after turning the AF start flag ON (step S18), a focusing control is executed (step S20).

As shown in FIG. 6, the CPU 46 first acquires evaluation value V_{A} of the focus state detecting element 32A (step S22), and next acquires the evaluation value V_{B} of the other focus state detecting element 32B (step S24). Next, the CPU 46 determines whether the AF start flag is ON or not (step S26). As a result of that determination, if the AF start flag is ON, autofocusing control is executed, and if the AF start flag is OFF, manual focusing control is executed.

In the case of manual focusing control (when the AF start flag is OFF), the CPU 46 acquires position data FP of the focusing lens 16 from the focusing lens position detector 42 (step S28), and also acquires focusing command data FC from the focus command circuit 38 (step S30). Then, based on the acquired position data FP of the focusing lens 16 and the focus command circuit 38, the focusing velocity control data FS (FS=FP−FC) for moving the focusing lens 16 to the focus position operated by the focus command circuit is computed (step S32). Then the calculated moving velocity is output as focusing velocity control data FS to the focus motor driving circuit 36 (step S34). The focus motor driving circuit 36 drives the focusing motor 40 based on the focusing velocity control data FS from the CPU 46, and moves the focusing lens 16 to the focus position operated by the focus command circuit 38.

On the other hand, in the case of autofocusing control (when the AF start flag is ON), first the CPU 46 computes the difference ΔV (ΔV=V_{A}−V_{B}) between the evaluation values V_{A} and V_{B} acquired from the focus state detecting elements 32A and 32B (step S36).

As stated above, the difference ΔV of the evaluation values acquired from the pair of focus state detecting elements 32A and 32B expresses the focusing state of an object image formed on the image detecting plane (focused image plane P) of the image detecting element for image production, and when the adjustable focus imaging lens 10 is in the in-focus state, the difference ΔV is zero. Therefore, the CPU 46 determines whether or not the calculated difference ΔV of the evaluation values is zero (step S38). If the difference is not zero, the CPU determines that an in-focus state is not achieved and executes focusing control. Namely, the calculated difference ΔV of the evaluation values sets the focusing velocity control data FS (step S40) that is output to the focus motor driving circuit 36 (step S34). The focus motor driving circuit 36 drives the focusing motor 40 based on the focusing velocity control data FS from the CPU 46 to move the focusing lens 16.

The CPU 46 repeats the above processing until the difference ΔV of the evaluation values becomes zero. When the difference ΔV of the evaluation values becomes zero, the CPU 46 turns the AF start flag OFF (step S42) and ends autofocusing control. Then, the CPU 46 acquires the position data FP of the focusing lens 16 from the focusing lens position detector 42 and rewrites the focus command data FC by the focus command circuit 38 to make it coincide with the present position of the focusing lens 16 (FP=FC) (step S44). Subsequently, the CPU 46 executes the manual focusing control based on the operation of the focus command circuit 38, and when the AF switch 48 is turned ON, the CPU 46 again executes autofocus control based on the difference ΔV of the evaluation values acquired from the pair of focus state detecting elements 32A and 32B.

As explained above, according to an imaging system of Embodiment 1 of the present invention, because the focus state is detected based on evaluation values from a pair of focus state detecting elements 32A and 32B, as compared with the case of using three focus state detecting elements for detecting the focus state, more object light can be made incident on the image detecting element for image production. Namely, for example, in a TV camera system according to Embodiment 1 of the present invention, only one-third of the object light received by the adjustable focus imaging lens 10 is separated as object light for focus state detection in order to provide one-sixth of the object light received by the adjustable focus imaging lens 10 equally to each of the focus state detecting elements 32A and 32B. When three focus state detecting elements are used, one-half of the object light received by the adjustable focus imaging lens 10 must be separated as object light for focus state detection in order to provide one-sixth of the object light received by the adjustable focus imaging lens 10 equally to each of the three focus state detecting elements. Thus, the TV camera system using three focus state detecting elements would provide one-sixth less light to the image detecting element for image production than a TV camera system according to Embodiment 1 of the present invention.

Although Embodiment 1 of the present invention separates one-third of the object light received by the adjustable focus imaging lens 10 as object light for focus state detection, the amount of object light for detecting the focusing state is not limited to that value.

In any case, by using only evaluation values from a pair of focus state detecting elements, the configuration of the optical system for detecting the focusing state becomes simpler than when three focus state detecting elements are used, thereby assisting in making the focus detection system simpler and smaller.

Although in Embodiment 1 of the present invention, equal amounts of object light for detecting the focusing state from the first prism 30A and the second prism 30B are incident on their respective focus state detecting elements 32A and 32B, the present invention is not limited to that arrangement.

### Embodiment 2

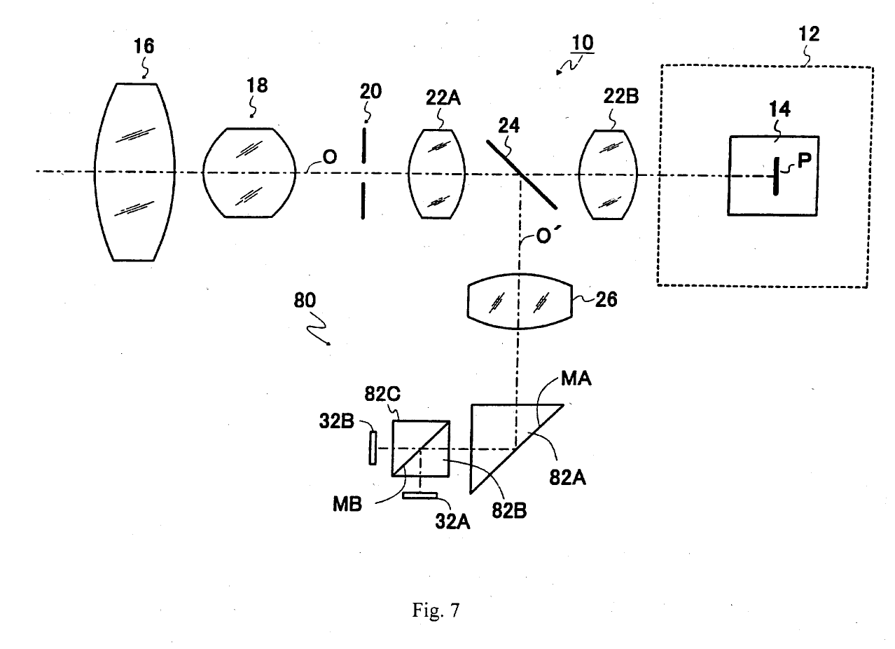

FIG. 7 shows a cross-sectional view of a camera using an AF system of Embodiment 2 of the present invention. Other than the focus state detection unit, Embodiment 2 of the present invention is the same as Embodiment 1 of the present invention. Therefore, the same reference numerals are given to the components that are unchanged from Embodiment 1 of the present invention and their descriptions are not repeated. Consequently, primarily only differences between Embodiment 2 and Embodiment 1 will be explained for Embodiment 2.

As shown in FIG. 7, in Embodiment 2 of the present invention, a focus state detection unit 80 includes three prisms, a first prism 82A, a second prism 82B, and a third prism 82C. The object light for focus state detection divided by the partially reflecting mirror 24 from the object light for image production proceeds along an optical axis O′ and enters the first prism 82A. Then, the light that enters the first prism 82A is reflected by a reflective face MA of the first prism 82A at a right angle and enters the second prism 82B. The object light that enters the second prism 82B is divided equally into reflected light and transmitted light by a partially reflecting surface MB of the second prism 82B. The light reflected at the partially reflecting surface MB is incident on the image receiving surface at the image detecting plane of the focus state detecting element 32A, and the light transmitted at the partially reflecting surface MB is incident on the image receiving surface at the image detecting plane of the focus state detecting element 32B.

Preferably, the focus state detection unit 80 is configured so that one-sixth of the object light received by the adjustable focus imaging lens 10 becomes incident on each of the focus state detecting elements 32A and 32B.

### Embodiment 3

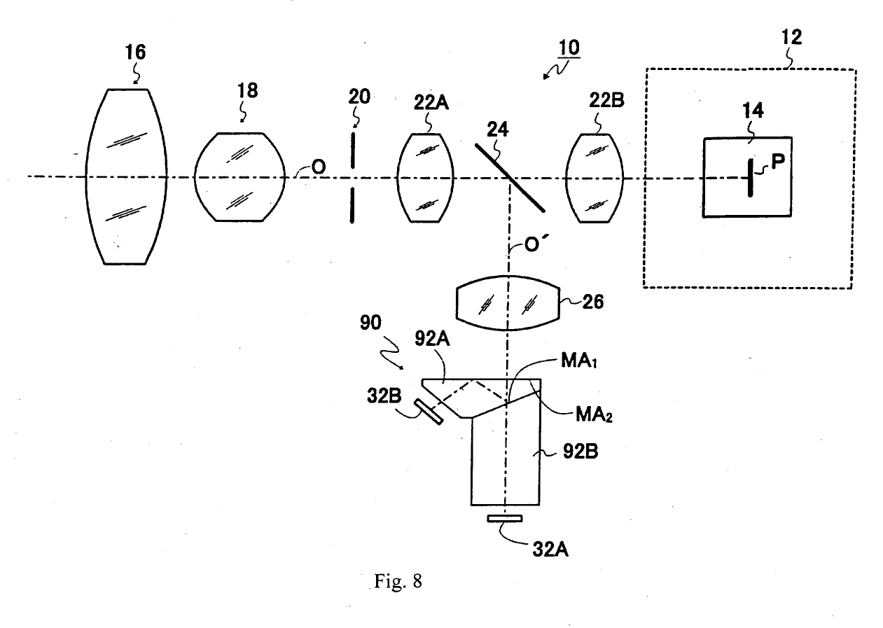

FIG. 8 shows a cross-sectional view of a camera using an AF system of Embodiment 3 of the present invention. Other than the focus state detection unit, Embodiment 3 of the present invention is the same as Embodiment 1 of the present invention. Therefore, the same reference numerals are given to the components that are unchanged from Embodiment 1 of the present invention and their descriptions are not repeated. Consequently, primarily only differences between Embodiment 3 and Embodiment 1 will be explained for Embodiment 3.

As shown in FIG. 8, in Embodiment 3 of the present invention, a focus state detection unit 90 includes two prisms, a first prism 92A and a second prism 92B. The object light for focus state detection divided by the partially reflecting mirror 24 from the object light for image production proceeds along an optical axis O′ and first enters the first prism 92A through prism face MA₂. Then, the light that enters through prism face MA₂ is divided equally into reflected light and transmitted light by a partially reflecting surface MA₁ of the first prism 92A. The light reflected by the partially reflecting surface MA₁ of the first prism 92A is reflected back to prism face MA₂ where it is internally reflected to exit first prism 92A to be incident on the image receiving surface at the image detecting plane of focus state detecting element 32B. The light transmitted at partially reflecting surface MA₁ of the first prism 92A is incident on the image receiving surface at the image detecting plane of focus state detecting element 32A.

Preferably, the focus state detection unit 90 is configured so that one-sixth of the object light received by the adjustable focus imaging lens 10 becomes incident on each of the focus state detecting elements 32A and 32B.

Also, because the image transmitted to focus state detecting element 32A is not reflected within the focus state detection unit 90 and the image transmitted to focus state detecting element 32B is reflected twice within the focus state detection unit 90, the images are the same, that is, one image is not reverted relative to the other image, and therefore no image reverting process is required. This is in contrast to Embodiments 1 and 2 where the images received by the focus state detecting elements are reverted relative to one another based on the different number of reflections to the focus state detecting element 32A versus 32 B. In Embodiments 1 and 2, if a focus area is not set to the center of the imaging plane, it is necessary to perform reversion processing of the image received at one of the focus state detecting elements so that the effects of image reversion are eliminated. However, in the focus state detection unit 90 of Embodiment 3, this is not necessary because the images received at focus state detecting elements 32A and 32B are the same. As used herein, the terms “reverted” and “reversion” relate to a mirror image of an original image that may be formed by reflection of the original image about a central axis in the plane of the original image.

### Embodiment 4

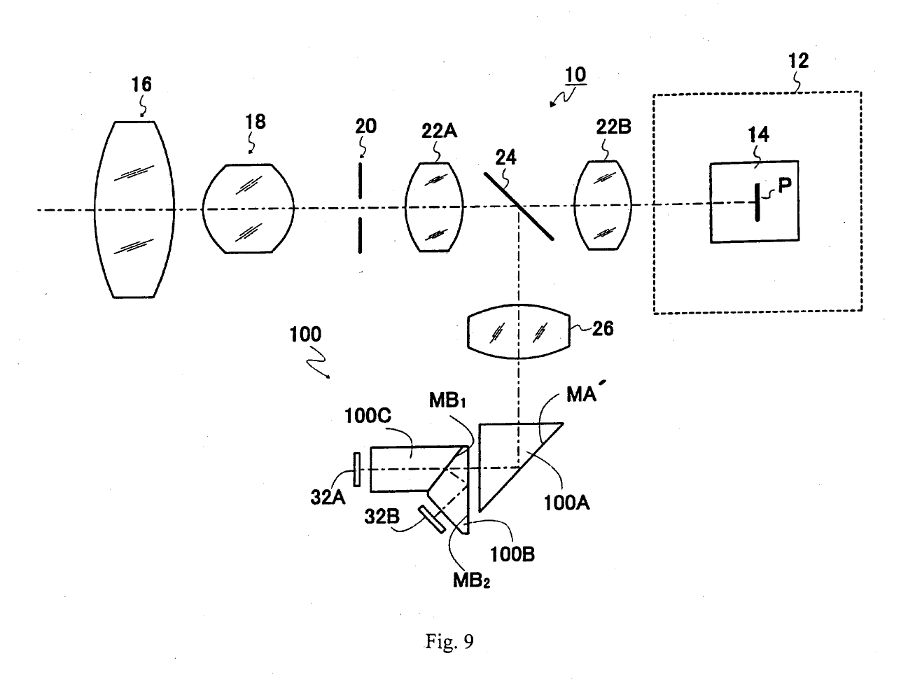

FIG. 9 shows a cross-sectional view of a camera using an AF system of Embodiment 4 of the present invention. Other than the focus state detection unit, Embodiment 4 of the present invention is the same as Embodiment 1 of the present invention. Therefore, the same reference numerals are given to the components that are unchanged from Embodiment 1 of the present invention and their descriptions are not repeated. Consequently, primarily only differences between Embodiment 4 and Embodiment 1 will be explained for Embodiment 4.

As shown in FIG. 9, in Embodiment 4 of the present invention, a focus state detection unit 100 includes three prisms, a first prism 100A, a second prism 100B, and a third prism 100C. The object light for focus state detection divided by the partially reflecting mirror 24 from the object light for image production proceeds along an optical axis O′ and enters the first prism 100A. Then, the light that enters the first prism 100A is reflected by a reflective face MA′ of the first prism 100A at a right angle and enters the second prism 100B through prism surface MB₂. The object light that enters the second prism 100B is divided equally into reflected light and transmitted light by a partially reflecting surface MB₁ of the second prism 100B. The light reflected by the partially reflecting surface MB₁ of the second prism 100B is reflected back to prism face MB₂ where it is internally reflected to exit second prism 100B to be incident on the image receiving surface at the image detecting plane of the focus state detecting element 32B. The light transmitted at the partially reflecting surface MB₁ is incident on the image receiving surface at the image detecting plane of focus state detecting element 32A.

Preferably, the focus state detection unit 100 is configured so that one-sixth of the object light received by the adjustable focus imaging lens 10 becomes incident on each of the focus state detecting elements 32A and 32B.

As in Embodiment 3 of the present invention, in Embodiment 4 of the present invention, the images are not reverted that are incident on the image receiving surfaces at the image receiving planes of focus state detecting elements 32A and 32B. Also, in the focus state detection unit 100 of Embodiment 4 of the present invention, by bending the object light for focus detection initially by the first prism 100A at a right angle, the height of the adjustable focus imaging lens in the direction of optical axis O′ is reduced, which assists in making the adjustable focus imaging lens 10 more compact.

The invention being thus described, it will be obvious that the same may be varied in many ways. For instance, the present invention may be used with all types of imaging systems, including camera systems that include a camera body and an adjustable focus imaging lens, including video cameras or similar cameras, still cameras that take static or single frame images, moving picture cameras, and including television cameras and photographic cameras. Additionally, although preferably equal amounts of light are provided to the light receiving surfaces of the focus state detecting elements, different amounts of light may be used, and, for example, the evaluation values adjusted by weighing factors inversely proportional to the relative amounts of light before a comparison is made. Also, although preferably evaluation values for comparison are determined at positions where the optical path length differences between the optical path lengths to each of the light receiving surfaces of each of the focus state detecting elements and the optical path length to a position conjugate with the light receiving surface of the image detecting element for image production are equal in magnitude and opposite in sign, that arrangement may be varied. For example, different optical path length differences might be used and the evaluation values adjusted by weighting factors, as discussed above, or different amounts of light may be directed to the different light receiving surfaces of the focus state detecting elements, as discussed above, to similarly adjust for the different optical path length differences. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A focus detecting system for determining the focus state of an adjustable focus imaging lens in an imaging system designed to form an image of an object, the focus detecting system comprising:
first light dividing means for positioning along a first optical axis of the focus detecting system so that light that enters the adjustable focus imaging lens is divided at a position along the first optical axis by the first light dividing means between object light for image production that is directed along the first optical axis and object light for focus state detection that is directed along a second optical axis, wherein the amount of object light for image production is larger than the amount of light for focus state detection;
two focus state detecting elements, each of said two focus state detecting elements including a light receiving surface;
second light dividing means, positioned along the second optical axis, for receiving the object light for focus state detection from the first light dividing means and for dividing the object light for focus state detection so that each light receiving surface of each of said two focus state detecting elements receives part of the object light for focus state detection and all the object light for focus state detection is directed to the two focus state detecting elements, and the optical path length along the second optical axis to the light receiving surface of one of said two focus state detecting elements is unequal to the optical path length along the second optical axis to the light receiving surface of the other of said two focus state detecting elements;
evaluation means for obtaining evaluation values indicative of the sharpness of an image at each of said two focus state detecting elements; and
comparison means for comparing the evaluation values of the two focus state detecting elements and determining an in-focus state of the imaging system when the evaluation values of said two focus state detecting elements are equal.

2. The focus detecting system of claim 1, and further comprising: an image detecting element for image production that includes a light receiving surface along the first optical axis; wherein, when the adjustable focus imaging lens is focused to form an in-focus real image of the object at the light receiving surface of the image detecting element for image production and the comparison means determines that the evaluation values are equal, the light receiving surface of one of said two focus state detecting elements is a distance along the second optical axis that is behind the position of an image conjugate to said in-focus real image, said distance being equal to the distance along the second optical axis that the other of said two focus state detecting elements is in front of a position where an image conjugate to said in-focus real image would be formed but for the presence of the other of said two focus state detecting elements.

3. The focus detecting system of claim 1, wherein the evaluation means uses high frequency components of image signals from each of the two focus state detecting elements to determine the evaluation value of each of said two focus state detecting elements.

4. The focus detecting system of claim 1, and further comprising reverting means that helps direct focus state object light either reflected or transmitted by the second light dividing means toward one of said two focus state detecting elements so that images of the object that the focus state detecting elements detect are not reverted relative to one another.

5. The focus detecting system of claim 2, and further comprising reverting means that helps direct focus state object light either reflected or transmitted by the second light dividing means toward one of said two focus state detecting elements so that images of the object that the focus state detecting elements detect are not reverted relative to one another.

6. The focus detecting system of claim 3, and further comprising reverting means that helps direct focus state object light either reflected or transmitted by the second light dividing means toward one of said two focus state detecting elements so that images of the object that the focus state detecting elements detect are not reverted relative to one another.

7. The focus detecting system of claim 1, wherein the first light dividing means divides the light that enters the adjustable focus imaging lens so that two-thirds of the amount of light that enters the adjustable focus imaging lens is directed along the first optical axis as object light for image production.

8. The focus detecting system of claim 2, wherein the first light dividing means divides the light that enters the adjustable focus imaging lens so that two-thirds of the amount of light that enters the adjustable focus imaging lens is directed along the first optical axis as object light for image production.

9. The focus detecting system of claim 3, wherein the first light dividing means divides the light that enters the adjustable focus imaging lens so that two-thirds of the amount of light that enters the adjustable focus imaging lens is directed along the first optical axis as object light for image production.

10. The focus detecting system of claim 4, wherein the first light dividing means divides the light that enters the adjustable focus imaging lens so that two-thirds of the amount of light that enters the adjustable focus imaging lens is directed along the first optical axis as object light for image production.

11. The focus detecting system of claim 5, wherein the first light dividing means divides the light that enters the adjustable focus imaging lens so that two-thirds of the amount of light that enters the adjustable focus imaging lens is directed along the first optical axis as object light for image production.

12. The focus detecting system of claim 6, wherein the first light dividing means divides the light that enters the adjustable focus imaging lens so that two-thirds of the amount of light that enters the adjustable focus imaging lens is directed along the first optical axis as object light for image production.

13. The focus detecting system of claim 7, wherein the second light dividing means divides the focus state detecting light so that one-sixth of the amount of light that enters the adjustable focus imaging lens is directed toward the light receiving surface of each of said two focus state detecting elements.

14. The focus detecting system of claim 8, wherein the second light dividing means divides the focus state detecting light so that one-sixth of the amount of light that enters the adjustable focus imaging lens is directed toward the light receiving surface of each of said two focus state detecting elements.

15. The focus detecting system of claim 9, wherein the second light dividing means divides the focus state detecting light so that one-sixth of the amount of light that enters the adjustable focus imaging lens is directed toward the light receiving surface of each of said two focus state detecting elements.

16. The focus detecting system of claim 10, wherein the second light dividing means divides the focus state detecting light so that one-sixth of the amount of light that enters the adjustable focus imaging lens is directed toward the light receiving surface of each of said two focus state detecting elements.

17. The focus detecting system of claim 11, wherein the second light dividing means divides the focus state detecting light so that one-sixth of the amount of light that enters the adjustable focus imaging lens is directed toward the light receiving surface of each of said two focus state detecting elements.

18. The focus detecting system of claim 12, wherein the second light dividing means divides the focus state detecting light so that one-sixth of the amount of light that enters the adjustable focus imaging lens is directed toward the light receiving surface of each of said two focus state detecting elements.
